(19) United States
(12) Patent Application Publication
(10) Pub. No.: US 2014/0255786 A1
(43) Pub. Date: Sep. 11, 2014

(54) PREPARATION METHOD OF HOLLOW CARBON SPHERE AND CARBON SHELL-SULFUR COMPOSITE, HOLLOW CARBON SPHERE, AND CARBON SHELL-SULFUR COMPOSITE FOR SECONDARY LITHIUM SULFUR BATTERY

(71) Applicant: KOREA INSTITUTE OF SCIENCE AND TECHNOLOGY, Seoul (KR)

(72) Inventors: Si Hyoung OH, Gyeongsangbuk-do (KR); Won Il CHO, Seoul (KR); Seung Ho YU, Seoul (KR); Eon Sung SHIN, Gyeonggi-do (KR); Min Seop KIM, Seoul (KR)

(73) Assignee: KOREA INSTITUTE OF SCIENCE AND TECHNOLOGY, Seoul (KR)

(21) Appl. No.: 14/084,196

(22) Filed: Nov. 19, 2013

(30) Foreign Application Priority Data
Mar. 11, 2013 (KR) 10-2013-0025761

(51) Int. Cl. H01M 4/36

(52) U.S. Cl. CPC H01M 4/364
USPC 429/231.8

(57) ABSTRACT

A preparation method of a hollow carbon sphere includes preparing a hollow carbon sphere including fine pores by using mold particles and a material including metal-phthalocyanine. The prepared hollow carbon sphere has a carbon shell surface including fine pores, and the hollow carbon sphere may be impregnated with sulfur to prepare a carbon shell-sulfur composite and may be utilized as an anode material of a lithium-sulfur secondary battery. The carbon-sulfur composite material may improve extremely low electrical conductivity of sulfur, confine sulfur and lithium polysulfide originated from sulfur in the carbon shell in which fine pores are distributed to prevent lithium polysulfide having an extended chain structure from being dissolved in an electrolyte, minimize a shuttle reaction, reduce an overcharge amount between charging and discharging, and improve performance of a secondary battery. In addition, a method for mass-producing hollow carbon sphere and carbon shell-sulfur composite material is provided.

### CROSS-REFERENCE TO RELATED APPLICATION

Pursuant to 35 U.S.C. §119(a), this application claims the benefit of earlier filing date and right of priority to Korean Application No. 10-2013-0025761, filed on Mar. 11, 2013, the contents of which is incorporated by reference herein in its entirety.

### BACKGROUND OF THE INVENTION

1. Field of the Disclosure

The present disclosure relates to a preparation method of hollow carbon sphere and carbon shell-sulfur composite, a hollow carbon sphere, and a carbon shell-sulfur composite for an anode of lithium sulfur secondary battery, and more particularly, to prepare a hollow carbon sphere such that it can be mass-produced, and impregnated with sulfur to complement low electrical conductivity of sulfur and restrain a shuttle reaction to thus provide an anode material of a lithium-sulfur secondary battery. A high capacity secondary battery using sulfur can be provided by applying the carbon shell-sulfur composite as an anode material.

2. Background of the Disclosure

Unlike a primary battery which is dischargeable once, a secondary battery is an electric storage device which is continuously charging and discharging. Spurred by the development in portable electronic devices since 1990s, demand for secondary batteries has been rapidly increased and is currently considered as essential electronic components.

Among various secondary batteries, lithium ion secondary batteries have come to prominence. Lithium ion secondary batteries, commercialized by Sony Corporation of Japan in 1992, have been used as core components of portable electronic devices such as smart phones, digital cameras, notebook computers, and the like, and contributed to the advent of information age. These lithium ion secondary batteries have extended to be utilized as power for charging in cleaners, gearing tools, and the like, developed to be utilized as a midsize batteries in a field such as electric bicycles, electric scooters, and the like, and as large batteries to be used in the field such as electric vehicles, hybrid electric vehicles (HEV), plug-in-hybrid electric vehicles (PHEV), various robots, middle or large power storage systems (ESS). Namely, demand for lithium ion secondary batteries has been rapidly increased.

However, even lithium secondary batteries having the excellent characteristics, among secondary batteries presented so far, have some problems to be used in transportation appliances such as an electric vehicle or a PHEV, and the biggest problem is a limitation in capacity.

Lithium secondary batteries are basically made of components such as an anode, an electrolyte, a cathode, or the like. Among them, the anode and the cathode materials determine capacity of a battery, so capacity of lithium ion secondary batteries is limited due to a material limitation of the anode and the cathode.

In particular, secondary batteries used for electrical vehicles or PHEVs are required to be used as long as possible once charged. That is, the biggest restrictions to the sale of electric vehicles are the distance, by which electric vehicles run after being recharged one time, shorter than that of vehicles of a general gasoline engine, and thus, discharge capacity of secondary batteries is performance that highly weighs in secondary batteries used for electrical vehicles or PHEVs.

In spite of great efforts, limitations in capacity of lithium secondary batteries cannot be resolved due to the structure of lithium secondary batteries and material restrictions. Thus, in order to fundamentally solve the problem of capacity of lithium secondary batteries, the development of an advanced concept secondary battery is required.

A lithium-sulfur secondary battery is a new, high capacity, low-priced battery system, which exceeds the limitation in capacity of an existing lithium ion secondary battery, replaces a transition metal used for a lithium ion secondary battery, and reduces cost.

Lithium ion and sulfur conversion reaction applied to a lithium-sulfur secondary battery is S₈+16Li⁺+16e⁻→8Li₂S in an anode, and theoretical capacity thereof amounts to 1,675 mAh/g. Also, theoretical capacity of lithium metal applied to a cathode is 3,860 mAh/g, and thus, a battery system may be able to have a super-high capacity by using them. Also, since a discharge voltage is approximately 2.2V, a theoretical energy density amounts to 2,600 Wh/Kg on the basis of amounts of an anode active material and a cathode active material. This value is greater by six to sevenfold than 400 Wh/kg, theoretical energy density of a commercial lithium secondary battery (LiCoO₂/graphite) which uses a layered metal oxide and graphite.

Since the fact that performance of lithium-sulfur secondary batteries could be remarkably improved through formation of nano-composites was known in 2010, lithium-sulfur secondary batteries have come to prominence as novel, high capacity, environmentally-friendly, low-priced lithium secondary batteries, and research into lithium-sulfur secondary batteries have been actively conducted as current next-generation battery systems over the world.

One of major problems of lithium-sulfur secondary batteries known so far is that electrical conductivity of sulfur is approximately 5.0×10⁻¹⁴ S/cm, close to a non-conductor, and thus, an electrochemical reaction in an electrode is not easy, and actual discharge capacity and voltage fall far short of theoretical values due to a very high overvoltage. In order to effectively solve the foregoing problems, as in an example of LiFePO₄ (electrical conductivity: 10⁻⁹˜10⁻¹⁰ S/cm), one of other anode active materials, a grain size is required to be reduced to tens of nanometers or smaller and surface treatment is required to be performed with a conductive material. In an early stage, researchers tried to improve the problems through a method such as mechanical ball milling of sulfur and carbon or surface coating using carbon, but to no avail. Also, attempts to solve the problems by applying a physical method (high energy ball milling) and various other chemical methods (melt impregnation into porous carbon nano-structures having a nano-size or metal oxide structures) have been reported.

Another major problem related to a lithium-sulfur secondary battery is that lithium polysulfide, an intermediate product of sulfur generated in the course of discharging, is dissolved in an electrolyte. As discharging proceeds, sulfur (S₈) continuously reacts to lithium ions, and thus, a phase thereof is successively changed from S₈→L₂S₈→(Li₂S₆)→Li₂S₄→Li₂S₂→Li₂S. Here, Li₂S₈, Li₂S₄ (lithium poly sulfide) having a chain form in which sulfur is prolonged in line, and the like, has properties that it is easily dissolved in a general electrolyte used in a lithium ion battery. When such a reaction takes place, reversible anode capacity is significantly reduced and dissolved lithium polysulfide spreads to a cathode to cause various side reactions. In particular, lithium polysulfide causes a shuttle reaction during a charging process, which results in a continuous increase in charging capacity, drastically degrading charging and discharging efficiency.

Recently, in order to solve such problems, various methods have been proposed: 1) a method of improving an electrolyte; 2) a method of improving the characteristics of an anode; 3) a method of improving a surface of the lithium cathode, and the like.

The method of improving electrolyte is a method for restraining a shuttle reaction by controlling a speed at which polysulfide spreads to a cathode, which uses a new electrolyte such as a functional liquid electrolyte having a new composition, a polyelectrolyte or an ionic liquid to restrain polysulfide from being dissolved to electrolyte by using novel electrolyte, or to adjust viscosity of an electrolyte, or the like.

The method of improving the characteristics of the anode includes a method of forming a coating layer on a surface of anode particles in order to prevent dissolution of polysulfide, a method of adding a porous material adsorbing dissolved polysulfide, and the like. Typically, a method of coating a surface of an anode structure including sulfur particles as a conductive polymer, a method of coating a surface of an anode structure with a metal oxide in which lithium ions are conducted, a method of adding a porous metal oxide which has a large specific surface area and large pores capable of absorbing a large amount of lithium polysulfide, a method of attaching a function group capable of adsorbing lithium polysulfide to a surface of a carbon structure, a method of covering sulfur particles by using graphene, a graphene oxide, and the like, have been proposed.

Finally, research into controlling a shuttle reaction by improving the characteristics of SEI formed on a cathode surface has been actively conducted. Typically, a method of controlling a shuttle reaction by forming an oxide film such as LiₓNO_{y}, LiₓSO_{y}, or the like, on a surface of a lithium cathode by applying an electrolytic additive such as LiNO₃, a method of forming a thick functional SEI layer on a surface of lithium metal, and the like, may be provided.

### SUMMARY OF THE DISCLOSURE

Therefore, an aspect of the detailed description is to prepare a hollow carbon sphere having fine pores such that it can be mass-produced, and impregnated with sulfur to complement low electrical conductivity of sulfur and restrain a shuttle reaction to thus provide an anode material of a lithium-sulfur secondary battery.

To achieve these and other advantages and in accordance with the purpose of this specification, as embodied and broadly described herein, a preparation method of a hollow carbon sphere includes the steps of: (1) mixing mold particles and a material including metal-phthalocyanine to prepare a mixed material; (2) heat-treating the mixed material under the condition of an inert atmosphere to form a carbon shell-mold particle composite which is mold particle covered with a carbon layer including fine pores; and (3) removing the mold particles from the carbon shell-mold particle composite to obtain a hollow carbon sphere having carbon sphere including fine pores and an internal space thereof.

The heat treatment of the step (2) may be performed at a temperature ranging from 400□ to 1,200□. The heat treatment of the step (2) may be performed at a temperature ranging from 7001□ to 1,200□ for one to 24 hours.

In the step (1), the mixed material may contain mold particles and metal-phthalocyanine in the ratio of 1:0.1 to 10 by weight.

Each fine pores of the hollow carbon sphere may have a size ranging from 0.5 nm to 50 nm.

The carbon shell forming a wall surface of the hollow carbon sphere has to an intensity ratio, I_{G}/I_{D} value, of a G band to a D band by Raman spectrum may range from 0.7 to 100.

A specific surface area of the hollow carbon sphere based on the Brunauer-Emmett-Teller (BET) equation may range from 50 to 2000 m²/g.

The metal included in metal-phthalocyanine may be any one selected from the group consisting of Fe, Co, Ni, Mn, Cu, Mg, Li, Zn, Ag, Pb and combinations thereof.

The mold particles may be selected from the group consisting of silica, aluminosilicate, alumina, and combinations thereof.

The step (3) may comprise a process of etching the mold particles by applying an etching solution including an hydrofluoric acid aqueous solution or an alkali aqueous solution.

To achieve these and other advantages and in accordance with the purpose of this specification, as embodied and broadly described herein, a preparation method of a carbon shell-sulfur composite includes the steps of: (4) mixing a hollow carbon sphere having fine pores fabricated according to the foregoing method with sulfur; and (5) maintaining the mixture of hollow carbon sphere and sulfur at a temperature equal to or higher than 115□ to allow the hollow carbon sphere to be impregnated with the molten sulfur to fabricate a carbon shell-sulfur composite.

To achieve these and other advantages and in accordance with the purpose of this specification, as embodied and broadly described herein, a hollow carbon sphere comprises a carbon material having a hollow structure of a carbon shell and an internal space of the carbon shell, wherein an I_{G}/I_{D} value, an intensity ratio of a G band to a D band of the carbon shell by a Raman spectrum, may range from 0.7 to 100. The carbon shell includes fine pores distributed on and in the carbon shell, and each size of the pores may range from 0.5 to 50 nm.

A size of internal space of the hollow carbon sphere may range from 10 to 1,000 nm. The carbon shell may have a thickness ranging from 1 to 50 nm.

A specific surface area of the hollow carbon sphere based on the is Brunauer-Emmett-Teller (BET) equation may range from 50 to 2,000 m²/g.

The hollow carbon sphere may further include a metal oxide.

To achieve these and other advantages and in accordance with the purpose of this specification, as embodied and broadly described herein, a carbon shell-sulfur composite for an anode of a lithium secondary battery includes the hollow carbon sphere according to the foregoing, and sulfur compound which is any one selected from the group consisting of sulfur, polysulfide, and a combination thereof. The sulfur compound may be positioned in an internal space of the hollow carbon sphere.

The carbon shell-sulfur composite may contain carbon shell and sulfur of the sulfur compound in a ratio of 1:1 to 1:9 by mass.

The carbon shell-sulfur composite may further comprise a metal oxide.

To achieve these and other advantages and in accordance with the purpose of this specification, as embodied and broadly described herein, a lithium-sulfur secondary battery includes: the foregoing carbon shell-sulfur composite as an anode material thereof.

Hereinafter, the present invention will be described in detail.

The present invention relates to a preparation method of a novel hollow carbon sphere and a novel carbon-sulfur composite. This material may be used for an anode of a lithium-sulfur secondary battery.

In order to solve a problem that sulfur has an extremely low electrical conductivity, various researches have been conducted. Conventionally, a method for forming a nano-composite of sulfur and carbon black through a mechanical method such as ball milling sulfur and carbon black, or the like, or a method for is forming a nano-composite by heating sulfur and impregnating the molten sulfur into a porous structure to form a nano-composite, and the like, have been largely used.

In the present embodiment, a novel method for preparing a hollow carbon sphere by which sulfur is positioned within a hollow carbon sphere to solve the problem of low electrical conductivity and a shuttle problem due to dissolution of polysulfide.

Through the foregoing method, a hollow carbon sphere having a predetermined size can be easily mass-produced at low cost, and since it has a graphite structure in which a thickness of a wall (shell) thereof ranges from a few to tens of nm, a large amount of sulfur may be applied to the interior of the hollow sphere. Also, since the hollow carbon sphere has excellent electrical conductivity, it can be advantageously used as a material of a lithium-sulfur secondary battery anode composite.

In an embodiment of the present invention, a preparation method of a hollow carbon sphere may include the step of: (1) mixing mold particles and a material including metal-phthalocyanine to prepare a mixed material; (2) heat-treating the mixed material under the condition of an inert atmosphere to form a carbon shell-mold particle composite which is mold particle covered with a carbon layer including fine pores; and (3) removing the mold particles from the carbon shell-mold particle composite to obtain a hollow carbon sphere having carbon shell including fine pores and internal space thereof.

The mold particles may serve as a mold in the process of forming a carbon shell, and after the carbon shell is formed, the mold particles are removed through etching, or the like, to form a hollow structure. The mold particles may is have a spherical shape but the shape of the mold particles is not limited. The spherical mold particles may not have a completely spherical shape and may have a shape close to a spherical shape such that it has a large space therein.

The mold particles may be made of a compound which rarely reacts to a metal catalyst at a high temperature, does not react to carbon to form carbide, and can be easily removed through etching after the formation of a carbon shell. Typically, silica may be used, but the present invention is not limited thereto. Preferably, silica, aluminosilicate, alumina, and a combination thereof may be used.

Also, the mold particles may have a relatively predetermined size ranging from 10 to 1,000 nm so as to be utilized as an anode material of a secondary battery together with sulfur.

Metal-phthalocyanine in the form of powder may be used. The metal may be any one selected from the group consisting of Fe, Co, Ni, Mn, Cu, Mg, Li, Zn, Ag, Pb, and a combination thereof, but the present invention is not limited thereto. Preferably, the metal included in metal-phthalocyanine may serve as a catalyst for changing the carbon shell into a structure having the properties of graphite or into graphite in the process of preparing the hollow carbon sphere, and when iron, nickel, cobalt, manganese, and the like, is included as metal, it may serve as an excellent catalyst.

The mold particles and metal-phthalocyanine may be mixed in a certain weight ratio in the step (1) and subsequently heat-treated in the step (2). Preferably, the mold particles and metal-phthalocyanine are used in a weight ratio of 1:01 to 10.

The heat treatment of the step (2) may be performed at a temperature ranging from 400□ to 1,200□ or at a temperature ranging from 400 to 1,000□ under the condition of an inert atmosphere such as nitrogen or argon. Also, the heat treatment of the step (2) may be performed at a temperature ranging from 700 to 1,200□ for 1 to 24 hours.

When the mixture of the mold particles and metal-phthalocyanine is heat-treated at a high temperature under an inert atmosphere, metal-phthalocyanine is decomposed in the vicinity of 400 to 600□ and amorphous carbon particles cling to the mold particles to form a thin amorphous carbon layer containing a great amount of nitrogen on a surface of the mold particles (a first heat treatment process). Here, the metal included in the metal-phthalocyanine may also be included in the carbon layer. The metal particles with the carbon layer formed thereon are continuously heat-treated and when a temperature thereof reaches 700 to 1,200□, nitrogen included in the carbon layer is released to from fine pores, and the amorphous carbon particles are changed to have a structure or properties of graphite (a second heat treatment process). Here, the metal originated from the metal-phthalocyanine and included in the carbon layer serves as a catalyst such that the amorphous carbon particles to have the structure or properties of graphite. In this manner, the heat treatment may be a stepwise heat treatment including the first heat treatment process and the second heat treatment process. However, the heat treatment may include only the process of performing heat treatment by maintaining the temperature ranging from 700 to 1,200□ for 1 to 24 hours, which corresponds to the second heat treatment process, while omitting the first heat treatment process.

The carbon shell-mold particle composite prepared through the foregoing process has such a form that the carbon shell having graphite or the qualities of graphite has fine pores distributed on and in the carbon shell, and the carbon shell has the characteristics very similar to those of the graphite structure, having very high electrical conductivity.

The mold particles of the carbon shell-mold particle composite may be removed to form a hollow carbon sphere, and in this case, the mold particles may be removed through a method using an etching solution including a hydrofluoric acid aqueous solution or alkali solution.

FIG. 1 is a conceptual view illustrating a process of preparing a hollow carbon sphere having a wall of a graphite structure according to an embodiment of the present invention. When silica powder having the same particle size is uniformly mixed with a certain amount of iron phthalocyanine powder and heat-treated under an inert atmosphere, phthalocyanine starts to be decomposed at a temperature ranging from 400 to 5001□ and a decomposition product cling to the periphery of silica to form a thin amorphous carbon layer containing a great amount of nitrogen around silicon. Heat treatment is continuously performed, and when a temperature of heat treatment reaches 900□, the metal particles (iron) of phthalocyanine serves as a catalyst and nitrogen is released from the carbon layer and the carbon layer has a graphite structure. After the heat treatment is finished, silicon is removed from the hydrofluoric acid or the alkali aqueous solution to synthesize a hollow spherical carbon structure (or a hollow carbon sphere).

The carbon shell-mold particle composite may further include a metal. The metal may be any one selected from the group consisting of Fe, Co, Ni, Mn, Cu, Mg, Li, Zn, Ag, Pb, and a combination thereof, and may be originated from metal-phthalocyanine.

In the process of removing the mold particles (the step (3)), the metal may be removed together with the mold particles or may not be removed and remain in the hollow carbon sphere. When the metal remains in the hollow carbon sphere, the metal may remain as a metal oxide in the hollow carbon sphere, and the metal oxide may be an oxide of Fe, Co, Ni, Mn, Cu, Mg, Li, Zn, Ag, and Pb.

When the hollow carbon sphere, which further includes the metal oxide, forms a complex body with sulfur and is supplied to a secondary battery, it may serve to adsorb polysulfide during a charging and discharging process of the secondary battery and may be able to enhance performance of the secondary battery. In particular, when the removal of the mold particles is performed through etching using a base solution metal oxide may be further included in the hollow carbon sphere, and thus, when the hollow carbon sphere is used as a material of a lithium-sulfur secondary battery, it can enhance performance of the battery.

A size of the hollow of the hollow carbon sphere may range from 10 nm to 1000 nm, a thickness of a carbon shell thereof may range from 1 nm to 50 nm, and fine pores distributed in the carbon shell may range from 0.5 nm to 500 nm.

The thickness of the carbon shell may adjusted as necessary, and in this case, a carbon material, used to form a carbon shell having the foregoing thickness range, which has excellent electrical conductivity while sufficiently securing an internal space of a hollow carbon sphere can be provided.

Fine pores serves as passages through which an internal material is released in the process of removing the mold particles, and through which a material is impregnated into the hollow, i.e., the internal space of the hollow carbon sphere, in forming the nano-composites with a different material such as sulfur.

As for the carbon shell, I_{G}/I_{D}, i.e., an intensity ratio value between a D band (positioned in about 1310 cm⁻¹) and a G band (positioned in about 1570 cm⁻¹) by Raman spectrum, may range from 0.7 to 100. This value exhibits that the carbon shell has graphite structure having excellent conductivity, in comparison to 3 as I_{G}/I_{D} value of amorphous carbon.

In another embodiment of the present invention, a preparation method of a carbon shell-sulfur composite may include the steps of: (4) mixing a hollow carbon sphere having fine pores as described above with sulfur such that sulfur permeates into a carbon shell; and (5) maintaining the mixture of sulfur and the hollow carbon sphere and sulfur at a temperature of 115° C. or higher to allow the hollow carbon sphere to be impregnated with the molten sulfur through the fine pores to prepare a carbon shell-sulfur composite. The temperature in the process of preparing the carbon shell-sulfur composite may range from 120° C. to 250° C.

In the process of preparing the carbon shell-sulfur composite, sulfur is melted so as to permeate into (or so as to be imbued into) the hollow carbon sphere, so the process may be performed at a temperature higher than a melting point of sulfur. Preferably, the process of preparing carbon shell-sulfur composite may be performed at a temperature between a temperature at which sulfur has sufficient fluidity and a temperature at which sulfur is not sublimated to be released out of the hollow carbon sphere. Thus, the process may be performed within a temperature from 120° C. to 250° C.

Also, the process of preparing a carbon shell-sulfur composite may be performed within a temperature range from 145° C. to 165° C., and in this temperature range, concentration of liquid sulfur is the highest, so it can effectively permeate into the hollow carbon sphere.

In a specific embodiment of melt-impregnation, the hollow carbon sphere and sulfur are put into mortar in a predetermined weight ratio, and sufficiently mixed, put into a pelletizer, and thereafter, light pressure is applied thereto to form a pellet. The pellet is put into a vacuum oven and maintained at a temperature ranging from 150° C. to 200° C. Then, the molted sulfur is spread into the hollow carbon sphere through fine pores thereof to synthesize a carbon shell-surfur composite. The temperature ranging from 150° C. to 200° C. may be maintained for about 12 hours, for example.

The prepared carbon shell-sulfur composite may be utilized as an anode material of a lithium-sulfur secondary battery, and the low electrical conductivity of sulfur can be solved and performance of a lithium-sulfur secondary battery can be enhanced.

Sulfur has electrical conductivity of about 5.0×10⁻¹⁴ S/cm, close to non-conductor, which is rarely responsive to electrochemical reaction in an electrode, and a significantly high voltage may be generated, so an actual discharge capacity and voltage greatly fall short of theoretical values. In order to solve this problem, a hollow carbon sphere having a shell of a graphite structure having excellent electrical conductivity, and sulfur is positioned therein to enhance electrical conductivity.

Also, a problem in which lithium polysulfide is dissolved in electrolyte, one of major problems, can be solved by using the foregoing material. As charging and discharging is performed, sulfur (S₈) continuously reacts with lithium ions to have a phase continuously changing from S₈→L₂S₈→(Li₂S₆)→Li₂S₄→Li₂S₂→Li₂S, and the like. Among them, Li₂S₈, Li₂S₄ (lithium polysulfide), and the like, in a chain form in which sulfur stands in line elongatedly, has qualities that it is easily dissolved in a general electrolyte used in a lithium ion battery. However, when the carbon shell-sulfur composite according to an embodiment of the present invention is used, sulfur is positioned within a carbon shell and large polysulfide ions having a long chain form cannot be easily released from the carbon shell including sufficiently small fine pores and positioned within the composite. Then, an amount of polysulfide spreading to the cathode can be remarkably reduced, restraining a shuttle reaction and an amount of overcharge between charging and discharging can be considerably reduced.

In particular, when a metal oxide is further included in the carbon shell-sulfur composite, it may serve to adsorb polysulfide during the charging and discharging process of a secondary battery, further enhancing performance of a secondary battery.

A hollow carbon sphere according to another embodiment of the present invention is made of a carbon material having a hollow structure having a carbon shell and an internal space. The carbon shell has an intensity ratio value I_{G}/I_{D} between a D band and a G band by Raman spectrum, ranging from 0.7 to 100. The carbon shell includes fine pores distributed on and in the carbon shell, and the fine pores have a size ranging from 0.5 nm to 50 nm.

In the hollow carbon sphere, a carbon shell has a structure and qualities of graphite, having excellent electrical conductivity, and since it has an empty space (hollow), the hollow may be impregnated with a material as necessary. In addition, the carbon shell includes fine pores, so it can serve as a transfer path of a material, and since the size of the pores is sufficiently small, an outflow of a material having is a large size such as polysulfide can be minimized.

The hollow carbon sphere may have a specific surface area according to a BET method ranging from 50 to 2,000 m²/g. When the hollow carbon sphere has such a specific surface area, it can have excellent activity when utilized as an anode material of a secondary battery.

The hollow carbon sphere may further include a metal oxide. The metal oxide may be an oxide originated from metal-phthalocyanine, and may be an oxide of Fe, Co, Ni, Mn, Cu, Mg, Li, Zn, Ag, and Pb.

A carbon shell-sulfur composite according to another embodiment of the present invention, having excellent characteristics as a material for an anode of a lithium secondary battery, may include the hollow carbon sphere, sulfur, or derivatives thereof, and sulfur and its derivatives may be positioned in an internal space of the hollow carbon sphere.

Sulfur included in the carbon shell-sulfur composite may be included in a mass ratio of 1:1 to 1:9 on the basis of carbon. By appropriately using the ratio, low electrical conductivity and lithium polysulfide dissolution problem arising as high energy density of sulfur is maintained in an anode can be effectively solved.

The carbon shell-sulfur may further include a metal oxide.

The carbon shell-sulfur may be included as a material of an anode of a secondary battery to provide a lithium-sulfur secondary battery having high capacity by using sulfur. When the carbon shell-sulfur composite further includes a metal oxide, the metal oxide serves to adsorb polysulfide, further enhancing performance of a lithium-sulfur secondary battery.

In the present invention, a hollow carbon sphere can be prepared by using a simplified preparation method which is available for mass production, and a carbon shell-sulfur composite that can be utilized as a material of an anode of a lithium-sulfur secondary battery having excellent characteristics by using the hollow carbon sphere. The carbon shell-sulfur composite provides a material of an anode capable of solving the low electrical conductivity of sulfur and the problem of a shuttle reaction due to polysulfide.

The preparation method of a hollow carbon sphere and the preparation method of a carbon shell-sulfur composite are simple synthesizing method available for mass-production and provide a hollow carbon sphere and a carbon shell-sulfur composite excellently utilized as a material of an anode of a lithium-sulfur secondary battery. In the carbon shell including fine pores, liquid sulfur can be imbued into an internal space of the carbon shell through the fine pores, so the carbon shell can provide a material of composite carbons having the characteristics of sulfur and graphite can be provided, and insufficient electrical conductivity of sulfur can also be complemented. Also, the fine pores distributed on the shell surface of carbon are too small for lithium polysulfide to be released to the outside, restraining a shuttle reaction during an operation of a secondary battery, reducing an amount of overcharge between charging and discharging, to thus enhance performance of a lithium-sulfur battery.

Further scope of applicability of the present application will become more apparent from the detailed description given hereinafter. However, it should be to understood that the detailed description and specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWINGS

The accompanying drawings, which are included to provide a further understanding of the invention and are incorporated in and constitute a part of this specification, illustrate exemplary embodiments and together with the description serve to explain the principles of the invention.

In the drawings:

FIG. 1 is a conceptual view illustrating an example of a process of preparing a hollow carbon sphere having a wall of a graphite structure according to an embodiment of the present invention.

FIG. 2 is transmission electron microscope (TEM) images of hollow carbon spheres having a shell having a graphite structure synthesized according to an embodiment of the present invention.

FIG. 3 is a photograph of a carbon shell of a hollow carbon sphere of FIG. 2 taken by a high resolution TEM (HRTEM).

FIG. 4 is a graph showing an x-ray diffractive pattern of the hollow carbon sphere of FIG. 2.

FIG. 5 shows results obtained by calculating a specific surface area of powder of hollow carbon sphere having a shell having a graphite structure synthesized according to an embodiment of the present invention and a distribution of fine pores (inset graph) through a BJH (Barret-Joyner-Halenda) algorithm.

FIG. 6 is a graph showing RAMAN spectrum measurement results of powder of hollow carbon sphere having a shell having a graphite structure synthesized according to an embodiment of the present invention

FIG. 7 is SEM photographs of a hollow carbon sphere (a: top) and a carbon shell-sulfur composite (b: bottom) prepared according to the method of the present invention.

FIG. 8 is a view illustrating the results obtained by analyzing a component by EDS (Energy Dispersive X-ray Spectroscopy) by using the carbon shell-sulfur composite of FIG. 7.

FIG. 9 is a view illustrating X-ray diffractive pattern analysis results of a mixture (indicated by simple-grinding) of a hollow carbon sphere and sulfur and a carbon shell-sulfur nano-composite (indicated by melt-impregnation) formed through a heat treatment.

FIG. 10 is a view illustrating results obtained by thermally analyzing the carbon shell-sulfur composite of FIG. 7.

FIGS. 11 and 12 are views illustrating results of evaluating performance of an anode (HC) fabricated according to an embodiment of the present invention and an anode (KB) fabricated according to a comparison example.

FIGS. 13 and 14 are views illustrating results obtained by evaluating high rate charging and discharging characteristics of a lithium-sulfur secondary battery fabricated by using an anode fabricated according to an embodiment of the present invention at various current densities.

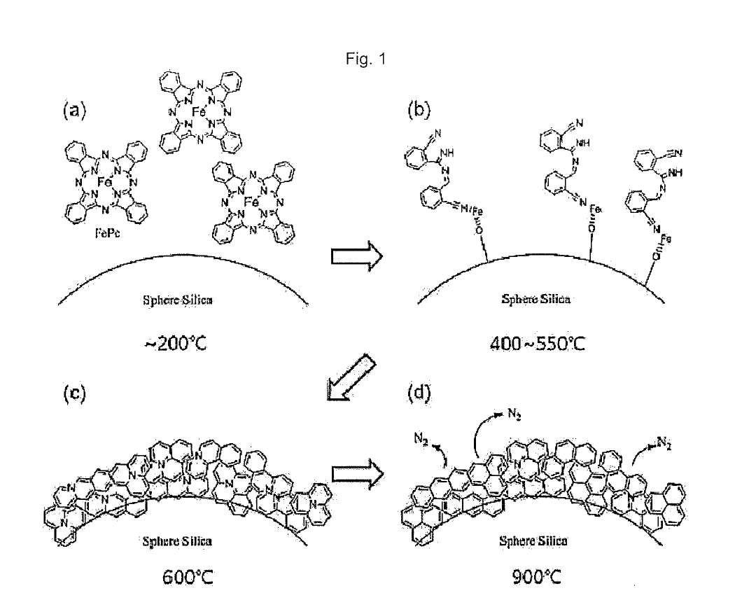

### DETAILED DESCRIPTION OF THE DISCLOSURE

Hereinafter, examples will be described in detail with reference to the accompanying drawings such that they can be easily practiced by those skilled in the art to which the present invention pertains. However, the present invention may be implemented in various forms and not limited to the examples disclosed hereinafter.

### Example 1

### Preparation of Hollow Carbon Sphere

Hereinafter, a process of preparing a hollow carbon sphere having a shell having a graphite structure will be described.

1 g of spherical silica (manufactured by Alfa Aesar company) having a size of 500 μm and 1 g of iron phthalocyanine were properly mixed to prepare a mixture material.

The mixture material was heat-treated at a temperature of 900□ for two hours under a nitrogen atmosphere to form a carbon shell-silica composite.

Powder obtained after the heat treatment was added to a 5% hydrofluoric acid aqueous solution, gently stirred for about one hour, and filtered, and the obtained hollow carbon sphere was dried. When filtering was performed, the hollow carbon sphere was sufficiently cleansed with distilled water and ethanol.

A crystallographical structure of the hollow carbon sphere synthesized through the foregoing process was observed through X-ray diffractive pattern and RAMA spectrum, the result showed that a carbon shell of the hollow carbon sphere was synthesized to have a graphite structure with high conductivity. Also, it was confirmed that the hollow sphere in shape was synthesized.

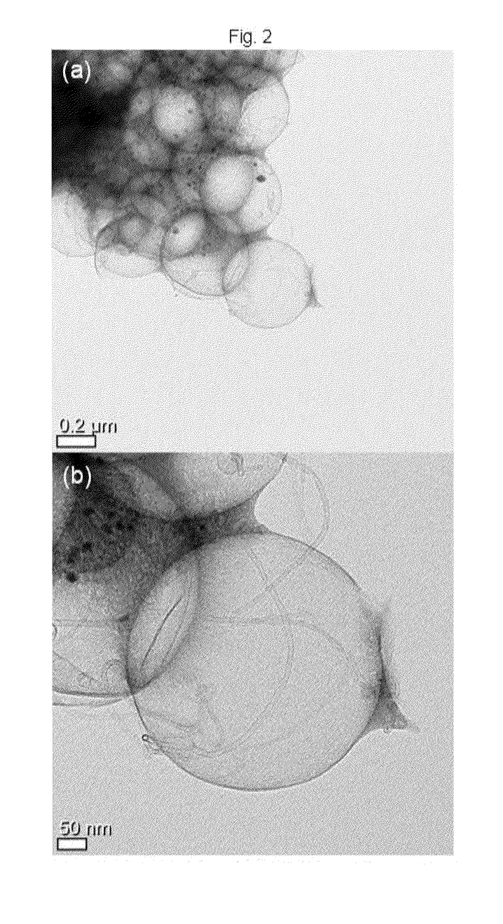

FIG. 2 is transmission electron microscope (TEM) images of hollow carbon spheres having a shell having a graphite structure synthesized according to an embodiment of the present invention. Referring to FIG. 2, it can be seen that a hollow carbon sphere having a very thin shell having a thickness of 10 nm or less was synthesized.

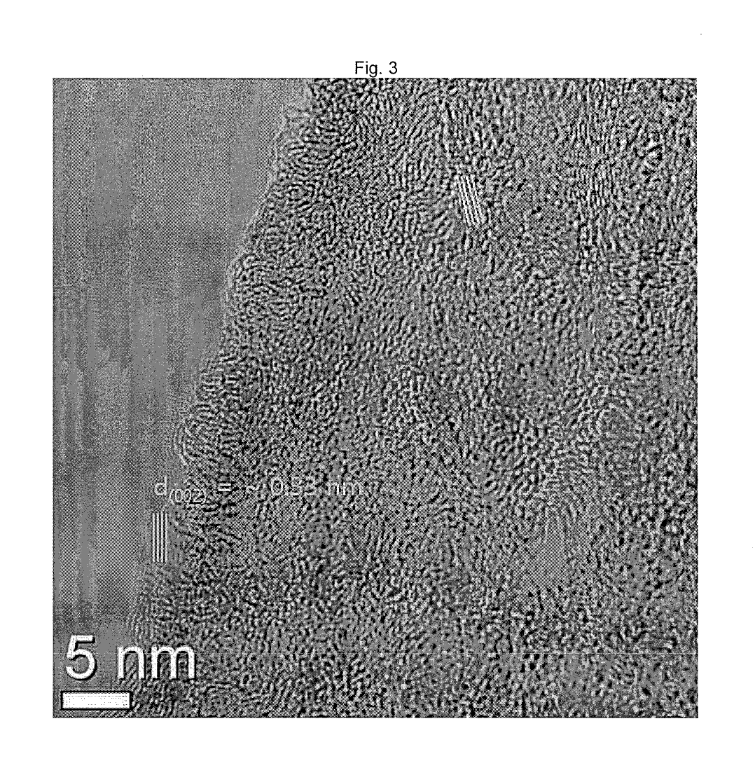

FIG. 3 is a photograph of a carbon shell of a hollow carbon sphere of FIG. 2 taken by a high resolution TEM (HRTEM). Referring to FIG. 3, it can be seen that the crystal structure of carbon has very uniform interlayer spaces locally, having similar characteristics to the structure of graphite.

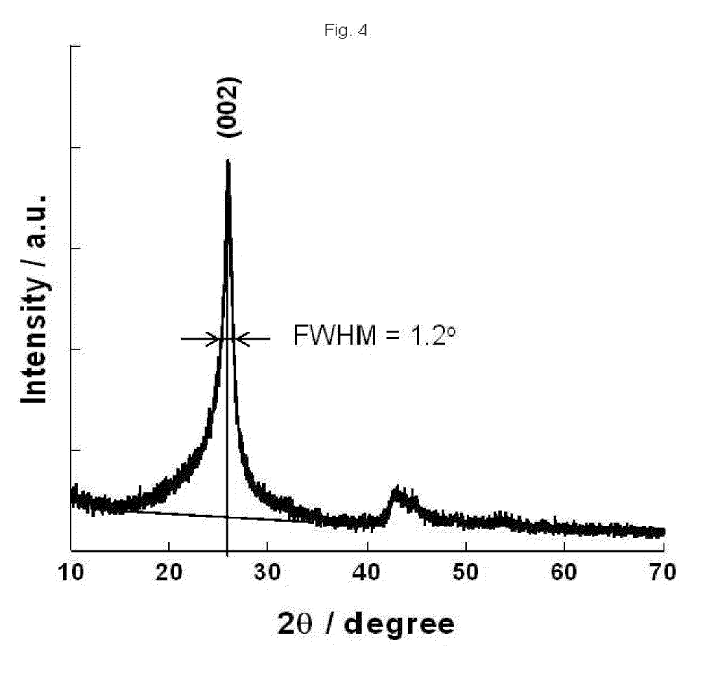

FIG. 4 is a graph showing an x-ray diffractive pattern of the hollow carbon sphere of FIG. 2. It can be seen that, in the X-ray diffractive pattern of the graph, a peak in a direction of [002] appears in the vicinity of 26° and a full width at half maximum (FWHM) of the peak represents about 1.2°, having the characteristics close to graphite.

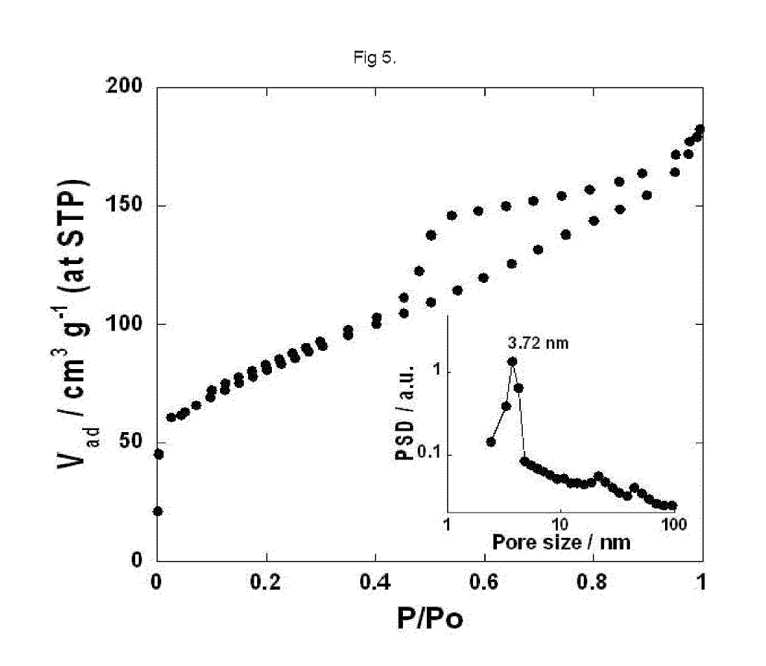

FIG. 5 shows results obtained by calculating a distribution of fine pores (inset graph) through a BJH (Barret-Joyner-Halenda) algorithm and a specific surface area of powder of hollow carbon sphere. According to the results of an adsorption test using nitrogen, a BET specific surface area was calculated as 297 m²/g, and according to results of calculation of a pore distribution by BJH (Barret-Joyner-Halenda), it was recognized that fine pores having a size of about 3.7 nm have been distributed. Such fine pores serve as passages along which sulfur particles spread into the hollow sphere in forming a carbon-sulfur nano-composite.

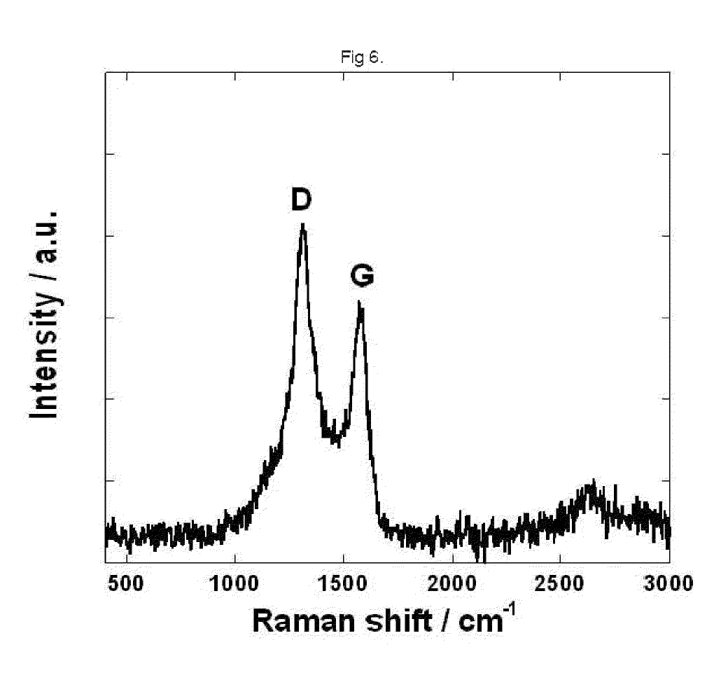

FIG. 6 is a graph showing RAMAN spectrum measurement results of powder of hollow carbon sphere having a shell having a graphite structure synthesized according to an embodiment of the present invention. In the RAMAN spectrum, an intensity ratio of (IG/ID) a G-band appearing in 1570 cm⁻¹ to a D band appearing in 1310 cm⁻¹ and is significantly greater than a ratio (0.3 or less) generally appearing in amorphous carbon, indicating that the shell of the graphite structure was well formed.

### Example 2

### Preparation of Carbon Shell-Sulfur Composite

Sulfur was inserted into the hollow carbon sphere synthesized according to example 1 by using melt-impregnation as described below.

0.1 g of hollow carbon sphere synthesized according to example 1 and 0.2 g of commercial sulfur powder were sufficiently mixed by using a mortar and then a pellet of the mixture was generated by using a pelletizer. This operation was to increase a contact area between the hollow carbon sphere and sulfur powder and to shorten a spread distance. The prepared pellet was put into a vacuum oven at a temperature of 165□, heated for six hours, taken out, and gently ground to prepare a carbon shell-sulfur composite.

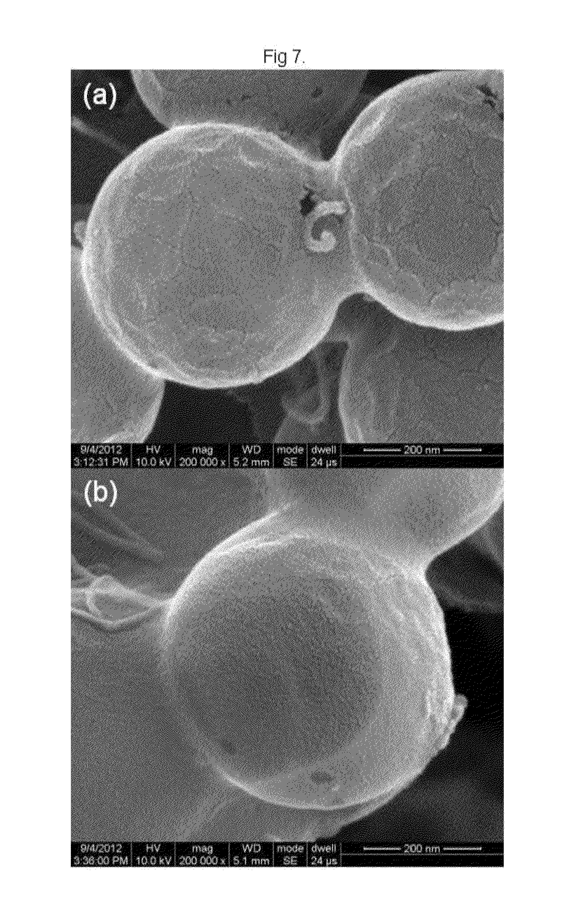

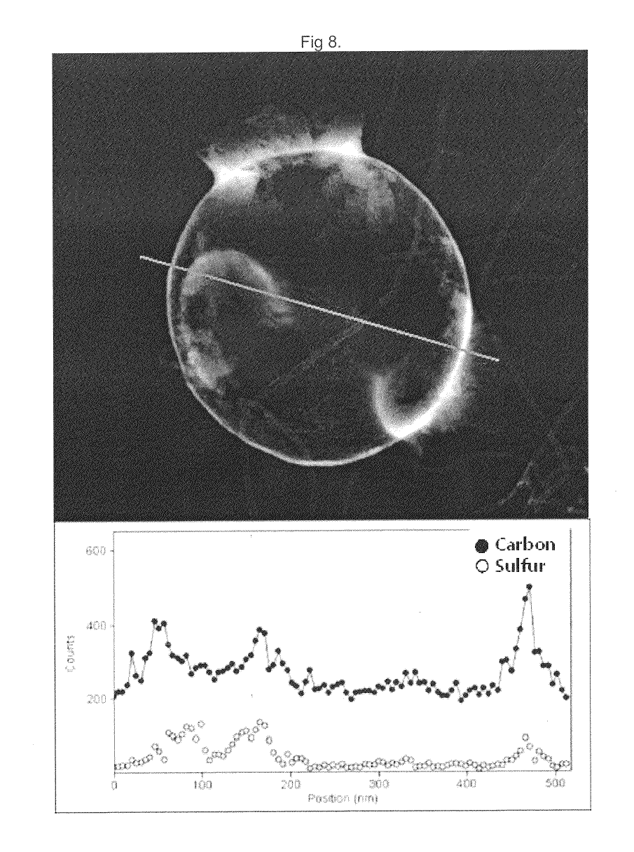

FIG. 7 is SEM photographs of a hollow carbon sphere (a: top) and a carbon shell-sulfur composite (b: bottom) prepared according to the method of the present invention. The shapes of the surfaces of particles in the two photographs are substantially same, indicating that sulfur permeated properly into the hollow sphere. Also, the results of analysis of components through EDS (Energy Dispersive X-ray Spectroscopy) by using the carbon shell-sulfur composite appearing in FIG. 8 show that sulfur permeated properly into the hollow sphere.

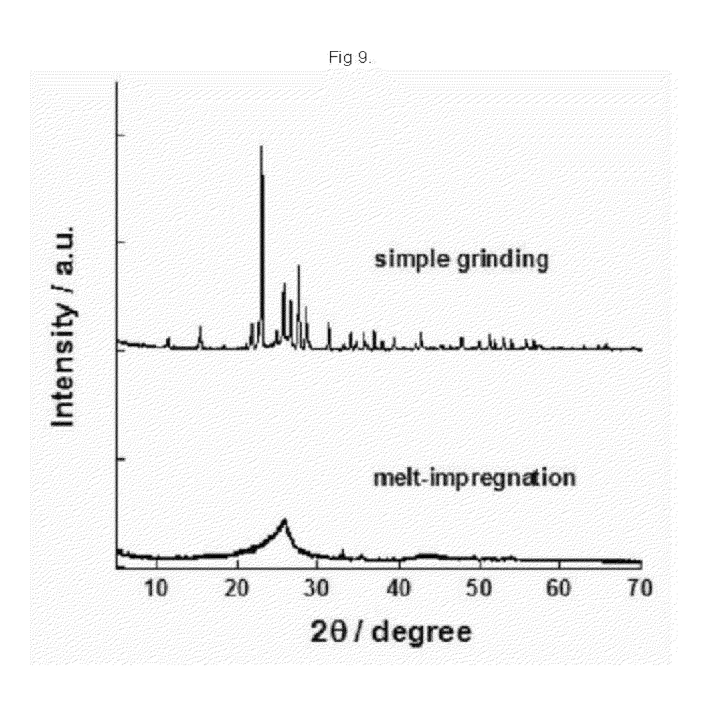

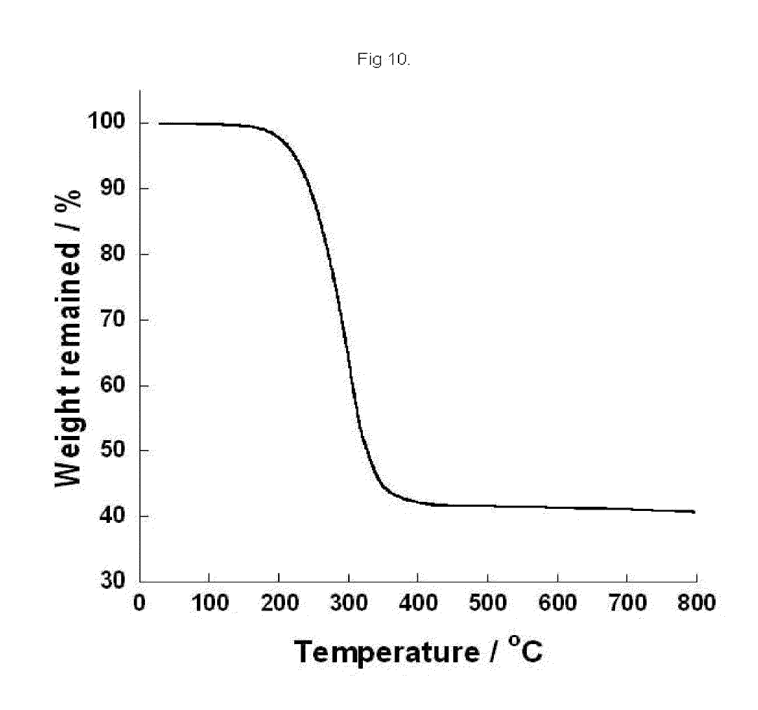

FIG. 9 is a view illustrating X-ray diffractive pattern analysis results of a carbon shell-sulfur mixture (indicated by simple-grinding) before the heat treatment and a carbon shell-sulfur nano-composite (indicated by melt-impregnation) formed through the heat treatment. Based on the X-ray diffractive pattern analysis, an XRD pattern of sulfur was conspicuously observed because a carbon shell-sulfur mixture before the heat treatment exists as a mixture in which sulfur and a carbon shell are simply mixed. However, after the heat treatment, in the carbon shell-sulfur nano-composite, the XRD pattern of sulfur did not appear in the XRD pattern, confirming that sulfur and carbon shell formed a composite. Namely, it can be seen that, after a formation of the composite, sulfur permeate into the hollow carbon sphere by nano-scale to form an amorphous phase, and it was confirmed that about 60% of sulfur by weight ratio existed in the composite according to the thermal analysis results of FIG. 10.

### Example 3

### Fabrication of Secondary Battery Using Carbon Shell-Sulfur Composite as Anode Material

An anode plate was fabricated by using the carbon shell-sulfur composite of example 2.

70 mg of the carbon shell-sulfur composite of example 2, 10 mg of acetylene black as a conducting material, and 10 mg of polyvinylidene fluoride (PVdF) as a binding material were uniformly dispersed in 0.6 g of normal methyl pyrrolidone (n-methyl-2-pyrrolidone, NMP) and mixed to form slurry. The slurry was coated on an aluminum foil by using a doctor blade (Dr. Blade) and dried in an oven at a temperature of 80□ to fabricate an anode.

The fabricated anode was cut in the form of a circular disk and used as an anode of a lithium sulfur secondary battery, and a lithium metal was used as a cathode, celgard 2500 was used as a separator, and 3.0 M LiTFSI{trifluoromethanesulfonimide, Li(N(SO₂CF₃)₂)} and {DME(dimethoxyethane):DOL(dioxolane)=1:1} in the ratio of 1:1 was used as an electrolyte. A 2032 coil cell was used as a battery type.

Maccor was used as charging/discharging equipment, and 0.1 C current was applied during first three cycles, and 0.5 C current was applied starting from a fourth cycle. The results are shown in FIG. 5, in which the highest capacity was 1200 mAh/g. Also, a stable behavior appeared during charging/discharging 100 times.

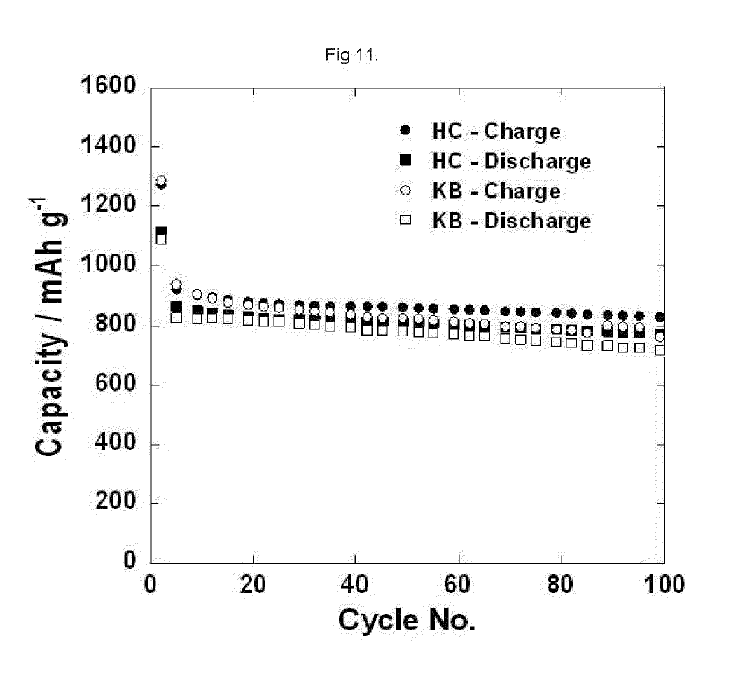

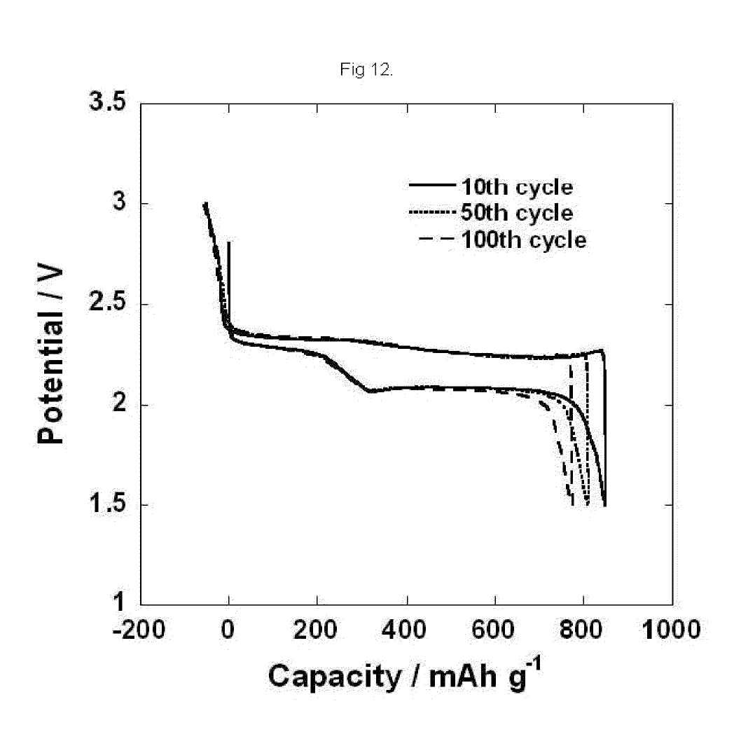

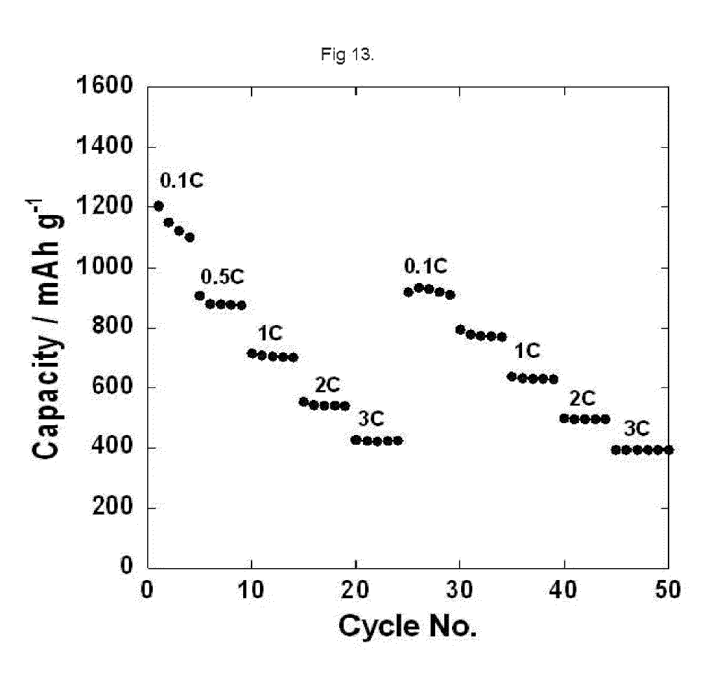

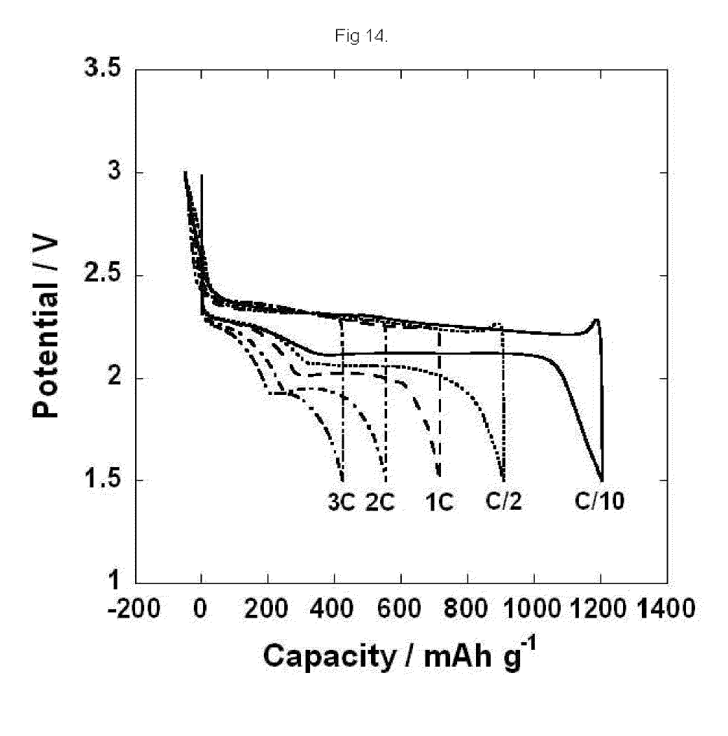

FIGS. 11 and 12 are views illustrating results of evaluating performance of an anode (HC) fabricated according to an embodiment of the present invention and an anode (KB) fabricated according to a comparison example, and FIGS. 13 and 14 are views illustrating results obtained by evaluating high rate charging and discharging characteristics of a lithium-sulfur secondary battery fabricated by using an anode fabricated according to an embodiment of the present invention at various current densities.

Referring to FIGS. 11 and 12, it can be seen that the case of applying a material using a hollow carbon sphere had a higher capacity retention rate after 100 cycles, in comparison to a case of using ball milling, and that a performance degradation phenomenon according to the progress of cycles is closely related to a formation of a solid phase such as Li₂S₂, Li₂S, or the like, during discharging. Namely, it was confirmed that overcharge generated due to a shuttle reaction as lithium polysulfide was dissolved in an electrolyte was partially improved as described above examples. This is because that sulfur was inserted into the hollow sphere to form lithium polysulfide therein, and thus an amount of lithium polysulfide dissolved in the electrolyte was reduced.

Referring to FIGS. 13 and 14, it can be seen that, according to the evaluation, when a current density was 1 C (=1.675 A/g), capacity was 710 mAh/g, and when a current density was 3 C (=5.025 A/g), capacity was 420 mAh/g, confirming that the capacity was significantly high, relative to the existing results. This is considered to result from the excellent electrical conductivity as the shell of the hollow sphere had a graphite structure, as shown in the results of TEM, XRD, RAMAN, and the like.

### Comparative Example

### Evaluation of Characteristics Using Mixture of Carbon Black and Sulfur

100 mg of carbon black (manufactured by Mitsibish Chemical company, Ketjen Black) and 200 mg of commercial sulfur powder were sufficiently mixed by using a mortar and then ball-milled by using commercial ball mill to prepare a carbon black-sulfur mixture.

The carbon black-sulfur mixture was applied as an anode material in the same manner as that of example 3, except that it was used instead of the carbon shell-sulfur composite of example 2, to fabricate a secondary battery of comparative example (indicated by KB in FIG. 11), and performance thereof was evaluated under the same conditions.

The foregoing examples and advantages are merely exemplary and are not to be considered as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary examples described herein may be combined in various ways to obtain additional and/or alternative exemplary examples.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds are therefore intended to be embraced by the appended claims.

What is claimed is:

1. A preparation method of a hollow carbon sphere, the method comprising the steps of:
(1) mixing mold particles and a material including metal-phthalocyanine to prepare a mixed material;
(2) heat-treating the mixed material under the condition of an inert atmosphere to form a carbon shell-mold particle composite which is mold particle covered with a carbon layer including fine pores; and
(3) removing the mold particles from the carbon shell-mold particle composite to obtain a hollow carbon sphere having carbon shell including fine pores and an internal space thereof.

2. The preparation method of claim 1, wherein the heat treatment of the step (2) is performed at a temperature ranging from 400° C. to 1,200° C.

3. The preparation method of claim 1, wherein the heat treatment of the step (2) is performed at a temperature ranging from 700° C. to 1,200° C. for one to 24 hours.

4. The preparation method of claim 1, wherein in the step (1), the mixed material contains the mold particles and the metal-phthalocyanine in the ratio of 1:0.1 to 10 by weight.

5. The preparation method of claim 1, wherein each fine pores of the hollow carbon sphere has a size ranging from 0.5 nm to 50 nm.

6. The preparation method of claim 1, wherein the carbon shell as a wall surface of the hollow carbon sphere has I_{G}/I_{D} value, as an intensity ratio of a G band to a D band by Raman spectrum, ranging from 0.7 to 100.

7. The preparation method of claim 1, wherein a specific surface area of the hollow carbon sphere based on the Brunauer-Emmett-Teller (BET) equation ranges from 50 to 2000 m²/g.

8. The preparation method of claim 1, wherein the metal included in metal-phthalocyanine is any one selected from the group consisting of Fe, Co, Ni, Mn, Cu, Mg, Li, Zn, Ag, Pb and combinations thereof.

9. The preparation method of claim 1, wherein the mold particles are selected from the group consisting of silica, aluminosilicate, alumina, and combinations thereof.

10. The preparation method of claim 1, wherein the step (3) comprises a process of etching the mold particles by applying an etching solution including an hydrofluoric acid aqueous solution or an alkali aqueous solution.

11. A preparation method of a carbon shell-sulfur composite, the method comprising the steps of:
(4) mixing a hollow carbon sphere having fine pores fabricated according to the method of claim 1 with sulfur; and
(5) maintaining the mixture of hollow carbon sphere and sulfur at a temperature equal to or higher than 115° C. to allow the hollow carbon sphere to be impregnated with the molten sulfur to fabricate a carbon shell-sulfur composite.

12. A hollow carbon sphere, comprising a carbon material having a hollow structure of a carbon shell and an internal space of the carbon shell,
wherein an I_{G}/I_{D} value of the carbon shell, an intensity ratio of a G band to a D band of the carbon shell by a Raman spectrum, ranges from 0.7 to 100, and
the carbon shall includes fine pores distributed on and in the carbon shell, and each size of the pores ranges from 0.5 to 50 nm.

13. The hollow carbon sphere of claim 12, wherein a size of the internal space of the hollow carbon sphere ranges from 10 to 1,000 nm.

14. The hollow carbon sphere of claim 12, wherein the carbon shell has a thickness ranging from 1 to 50 nm.

15. The hollow carbon sphere of claim 12, wherein a specific surface area of the hollow carbon sphere based on the Brunauer-Emmett-Teller (BET) equation ranges from 50 to 2,000 m²/g.

16. The hollow carbon sphere of claim 12, wherein the hollow carbon sphere further comprises a metal oxide.

17. A carbon shell-sulfur composite for an anode of a lithium secondary battery, comprising:
the hollow carbon sphere according to claim 12, and sulfur compound which is any one selected from the group consisting of sulfur, polysulfide, and a combination thereof;
wherein the sulfur compound is positioned in the internal space of the hollow carbon sphere.

18. The carbon shell-sulfur composite of claim 17, wherein the carbon shell-sulfur composite contains carbon of the carbon shell and sulfur of the sulfur compound in a ratio of 1:1 to 1:9 by weight.

19. The carbon shell-sulfur composite of claim 17, wherein the carbon shell-sulfur composite further comprises a metal oxide.

20. A lithium-sulfur secondary battery comprising the carbon shell-sulfur composite according to claim 17 as an anode material thereof.
